(19) United States
(12) Patent Application Publication
(10) Pub. No.: US 2001/0009553 A1
(43) Pub. Date: Jul. 26, 2001

(54) Dual speed end station and system

(76) Inventor: Magnus Homann, Goteborg (SE)

Correspondence Address: Ronald L. Grudziecki, Burns, Doane, Swecker & Mathis, L.L.P., P.O. Box 1404, Alexandria, VA, 22313-1404, US

(21) Appl. No.: 09/732,018

(22) Filed: Dec. 8, 2000

(30) Foreign Application Priority Data
Dec. 10, 1999 (SE) 9904528-8

(51) Int. Cl. H04L 12/413

(52) U.S. Cl. 370/445

(57) ABSTRACT

A dual speed end station (ESD, ESQ) having a first speed transceiver (T1) and a second higher speed transceiver (T2) for use in Ethernet systems and an Ethernet system adapted to be used with dual speed end stations have been described. The end station and systems according to the invention allows for an easy upgrading of Ethernet based systems over an infrastructure (IFR) comprising connection points separated into a first speed media section and a second higher speed media section, the first and second speed segments being connected by distinct media paths, and the dual speed end station being adapted for on a routine basis checking its current connection trough the respective first speed transceiver (T1) and second speed transceiver (T2) and by means of a media selector (MS, CMS) giving priority of communicating through the second speed transceiver.

### FIELD OF THE INVENTION

The present invention relates generally to a local area network system and an end station. In particular the present invention relates to systems working according to various Ethernet standards.

### BACKGROUND OF THE INVENTION

A multipoint data communication system with collision detection was originally described in U.S. Pat. No. 4,063,220. This data communication system, which later developed into the Ethernet standard, allowed several physically dispersed data processing stations to send and receive packets or frames of messages, over one shared media, such as a single conducting wire. The Ethernet system is defined in the IEEE 802.3 and other standards.

According to the Ethernet system, the Ethernet frame is a standardised set of bits used to carry data. It comprises a destination address, a source address and a payload of data.

The system utilises that stations are sending information to all other stations, which in turn only listens to messages meant for the particular station.

Since all stations in principle can induce signals on the shared media, a Media Access Control (MAC) Protocol, sets out the rules for gaining access to the shared channel. The Media access control protocols exists for half duplex systems operating over a single medium and full duplex operation communicating over separate transmit and receive media.

The central Ethernet mechanism, which makes communication over a shared medium possible, is that every station waits to send frames on the shared channel until the channel is absent from signals and that each station terminates sending frames if other stations happen to transmit frames within a so called initial time slot of a frame. The latter event is referred to as a collision and the stations coupled to one another over the shared medium is referred to as a collision domain. The above access method is referred to as CSMA-CD (Carrier Sense Multiple Access with Collision Detect).

In Ethernet, a back-off procedure defines that attempts to re-send non-successive frames are made according to a scheme, whereby a random waiting time for re-sending frames is chosen and whereby the random waiting time increases for each unsuccessful attempt to capture the channel. This mechanism provides for a smooth saturation of the communication channel whereby all stations in the collision domain have equal probabilities for performing a successful transfer of data.

Over the years, the original Ethernet system has evolved into many new Ethernet standards concerning various aspects of Ethernet components and media. The Ethernet has also developed into different systems facilitating increasing operating speeds while to a certain degree enabling the later developed systems to be backward compatible with components and media specified according to previous standards.

Ethernet has developed from providing operating speeds at 10 Mb/s, over 100 Mb/s and recently to 1000 Mb/s.

In FIG. 1, a simplified sketch of the various protocol layers of the Ethernet system according to the Open Standard Interface, OSI, model has been shown.

As illustrated in the figure both 10, 100 and 100 Mb/s Ethernet share the same Media Access Control (MAC) protocol, while the lower layers have different elements and protocols.

The 10 Mbps Ethernet layers comprises a MAC layer, a reconciliation layer, a Media Independent Interface layer, MII, a Physical Layer Signalling layer, PLS, an Attachment Unit Interface AUI, a Physical Medium Attachment, PMA, which attaches physically to the medium.

The 100 Mbps Ethernet comprises a MAC layer; a reconciliation layer; a Media Independent Interface layer, MII; a Physical Coding Sub-layer, PCS; a Physical Medium Attachment, PMA, or a Physical Medium Dependent interface, PMD which specifies the physical attachment to the medium.

The 1000 Mbps Ethernet layers comprise the same elements as the 100 Mb/s layers except that a Gigabit Media Independent Interface, GMII, is used instead of the Media Independent Interface, MII.

Other implementations of the 1000 Mbps Ethernet removes the need for visible GMII interface, and uses a ten-bit interface, TBI, as the open interface

One current Ethernet standard is the 100 Mbps twisted-pair media system (100 Base-TX) standard, which as the name indicates operates on two pairs of twisted wires, one for transmit signals, the other one for receive signals. The cable may be either shielded or non-shielded. Although media such as fibre optic cable and coax-cables generally offers both an extended range and speed, twisted wire is, apart from being flexible and cheap, often an interesting medium because it is installed in many buildings and used with older 10 Mbps systems.

Other standards operate at 1000 Mbps. The 1000 Base-LX based systems use fibre optic media and refers to a long wavelength laser providing operation at distances up to 3000 m. The 1000 Base-SX makes use of a short wavelength lasers, which provides for operation at distances for up to 300 m and are less expensive.

The 1000 Base-CX Ethernet segment makes use of shielded twisted pair wire and is specified for operation of up to 25 m length.

The 1000 Base-T Ethernet is based on the use of un-shielded twisted pair wires. Complex signalling processing implemented in special transceivers should compensate for cross talk and noise in this simple media and enable operation of up to 100 m. These devices are expected to be affiliated with a relatively high power consumption.

Not only is higher speed continuously evolving into new standards, also different capabilities are included in more recent versions of the Ethernet system. One such capability is the auto negotiation function, which provide automatic speed matching for multi-speed devices to communicate at the highest speed possible for all the devices coupled to a segment. It also enables devices to sense whether the other device in a segment is supporting full duplex operation and on this basis configures itself for optimum performance. The full duplex operation involves that two stations, such as a station and a switching hub, communicate via separate TX and RX connections. Since each connection carries information from only one sender, the media access control protocol for a shared medium is suspended in this mode.

The auto negotiation function involves for example, that if a dual speed 10/100 Ethernet interface supporting both 100 Base-TX and 10 Base-TX and equipped with auto negotiation is connected to a 10 Base-T hub that does not support auto negotiation, the interface will generate signals according to the auto negotiation protocol. The auto negotiation protocol in the interface will detect the presence of normal signals only and automatically place the interface in half duplex 10 Base-T mode.

100 Mbps components

By way of example, the components for 100 Base TX PHY end station has been shown in FIG. 2 and the components thereof shall be dealt with from left to right.

A Data Terminal Equipment, DTE, is shown at the left side of the drawing. This is the originating or terminating point for higher-level protocol data. It offers to the outside the Ethernet interface, XI, which may be coupled to an output port of a PC for instance. The data terminal equipment comprises the means performing media access protocol processing.

A MII (Media Independent interface) connector provides a 4-bit wide data path for transmit and receive data to and from a 100 base TX PHY transceiver together with various control signals. The 4-bit wide data path is clocked at 25 MHz to provide a 100 Mbps data transfer speed. The Data Terminal Equipment, DTE controls the transceiver over the control signals in the MII connector.

The 100 Base-TX transceiver comprises a physical coding sub-layer (PCS) device for conversion of MII signals to lower layer signals and a physical media attachment (PMA) device for converting lower layer signals to media signals, TX+, TX−, RX+, RX−.

The last step in the connection to the Ethernet media is a physical media dependent, PMD, connector for accomplishing the physical coupling to a twisted pair cable.

The 100 Base-TX transceiver supports full duplex, whereby independent transmit and receive paths are established through independent media paths. The transceiver may also support auto negotiation, for instance between 10 Mbps and 100 Mbps.

1000 Mbps components

In FIG. 2a, a 1000 Mbps end station has been shown, where a TBI (Ten Bit Interface) interface is used between the DTE and the PHY.

This end station corresponds largely to the 100 Mbps end station shown in FIG. 2.

However, the physical coding sub-layer, PCS, device found in the 100 Base TX transceiver of FIG. 2 is integrated in the data terminal equipment, DTE, and the data terminal equipment, DTE, communicates with the physical medium attachment, PMA, in the 1000 Base CX PHY transceiver over a ten bit interface, TBI.

Communication between the media access control, MAC, and the physical coding sublayer device, PCS, is accomplished by means of an internal interface (not shown).

The switching hub

As is known, a central element in many Ethernet systems is the switching hub or bridge, which connects end stations with one another and which operates on the layer 2 in the OSI model. The switching hub comprises a number of ports, which are not connected directly but through special switching mechanisms and circuitry such that the port represents a termination of the separate collision domains linked to the particular port.

The switching hub is transparent in function; that is, it configures automatically itself as stations are connected to its ports by its address learning capabilities. The bridge reads the destination address and the source address found in the Ethernet frame. When a station, connected to a given port of the switching hub, sends a frame, the source address of the frame is automatically associated with the given port at which it appeared. This information is dynamically updated for all ports in a forwarding database held in the switching hub. In this manner, the switching hub knows which port to switch incoming frames to. In case a frame should be sent to the same collision domain as it appears from, the switching hub simply avoids sending the frame further on. In this manner, local traffic relating to a given collision domain is filtered out and prevented from being sent to the other collision domains of the switching hub.

A bridge is normally provided with multiple interfaces or ports, which can operate at different speeds. Frames received on a fast port, but meant to be issued on a less fast port, are momentarily stored in a buffer memory in the bridge and sent on the given collision domain in accordance with the speed and the media access protocol which applies to the destination domain.

### SUMMARY OF THE INVENTION

Switching hubs available on the market today are normally containing a plurality of ports of which some are able to communicate at a first speed and only a limited number of ports are able to communicate at a second higher speed.

One problem associated with prior art Ethernet networks based on a switching hub, is that it requires extensive changes to the complete network to replace or upgrade an existing switching hub with a switching hub of greater capacity, i.e. a hub with more fast speed ports in relation to the existing switching hub.

It is a first object of the present invention to set forth an Ethernet system and an Ethernet end station, which provides for a flexible upgrading of an Ethernet system with regard to obtaining many high-speed communication paths.

The above objects have been accomplished by the Ethernet system according to claim 1 and the end stations as defined by claim 2 and 6, respectively.

It is another object to provide an Ethernet system and an Ethernet station, which consumes a minimum of power.

This object has for instance been accomplished by the subject matter set forth in claim 3.

It is another object to set forth an end station, which senses, which of two transceivers should be communicated over.

This object has been accomplished by the subject matter set forth in claim 7 and 8.

It is still another object to provide flexible upgrading in systems utilising at least two redundant, local area networks.

This object has been accomplished by the subject matter set forth in claim 12.

Further advantages will appear from the detailed description of the invention.

### BRIEF DESCRIPTION OF THE DRAWINGS

FIG. 1 shows various prior art Ethernet protocol layers relating to 10, 100 and 1000 MB/S Ethernet systems,

FIG. 2 shows the physical components of a prior art 100 Base-TX Ethernet end station,

FIG. 2a shows the physical components of a prior art 1000 Base-CX Ethernet end station,

FIG. 3 shows a first embodiment of an end station, ESD, according to the invention,

FIG. 3a shows a flow diagram relating to the end station, ESD, shown in FIG. 3,

FIG. 4 shows a coupling scheme for connecting the end station of FIG. 3 to a four pairs twisted wire media according to the invention,

FIG. 4b shows an alternative coupling scheme for a combined two pairs twisted wire media and a fibre media according to the invention [Please elaborate example]

FIG. 5 shows a plurality of prior art end stations of different speeds, ESL and ESH, coupled to a first switching hub, SW1, over a media infrastructure, FI, according to the invention based on the coupling scheme of FIG. 4,

FIG. 6 shows the same infrastructure, FI, and switch, SW1, as in FIG. 5, but with end stations according to the invention, ESD, replacing some of the prior art end stations, ESL and ESH,

FIG. 7 shows the same infrastructure, FI, and end stations as in FIG. 6, but with a second switch, SW2 replacing the first switch, SW1,

FIG. 8 shows the same infrastructure, end stations and switch as in FIG. 7, but with the end stations being re-arranged,

FIG. 9 shows a coupling of two end stations according to the invention over a fixed infra-structure according to the invention

FIG. 10 shows a coupling with an end station according to the invention with a conventional end station over a fixed infrastructure according to the invention,

FIG. 11 shows a second embodiment of an end station according to the invention,

FIG. 12 shows a third embodiment of an end station according to the invention,

FIG. 12a shows a routine relating to the embodiment shown in FIG. 12,

FIG. 13 shows a redundant dual speed end station according to the invention,

FIG. 14 shows a state diagram of the common media selector shown in FIG. 13,

FIG. 14a shows a signal used in the state diagram of FIG. 14, and

FIG. 15 shows the redundant dual speed end station shown in FIG. 13 coupled to redundant LAN's A and B through two switches.

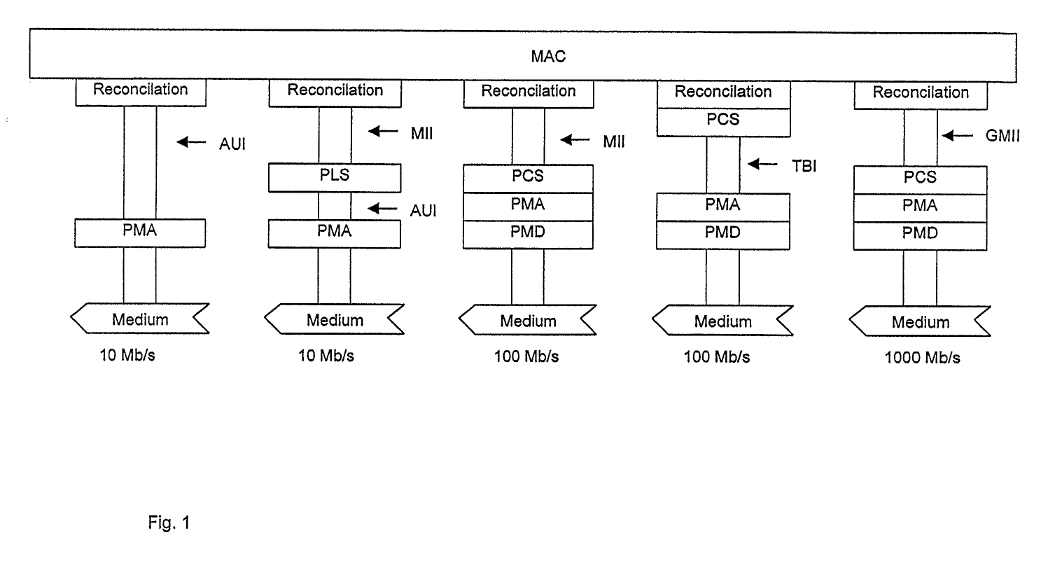

### DETAILED DESCRIPTION OF THE PREFERRED EMBODIMENTS OF THE INVENTION

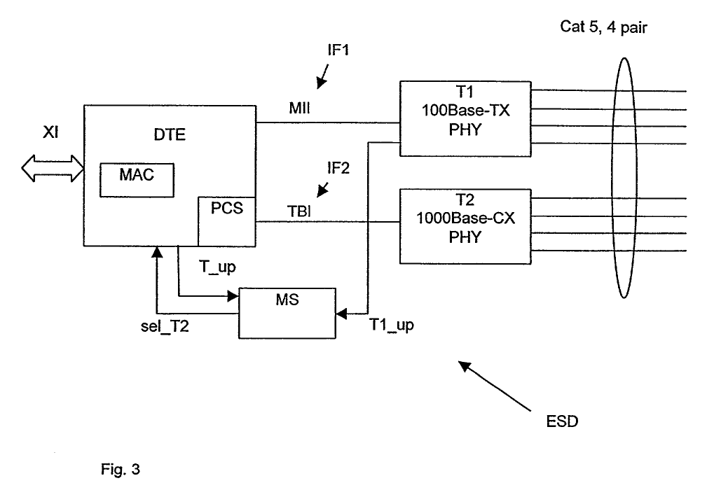

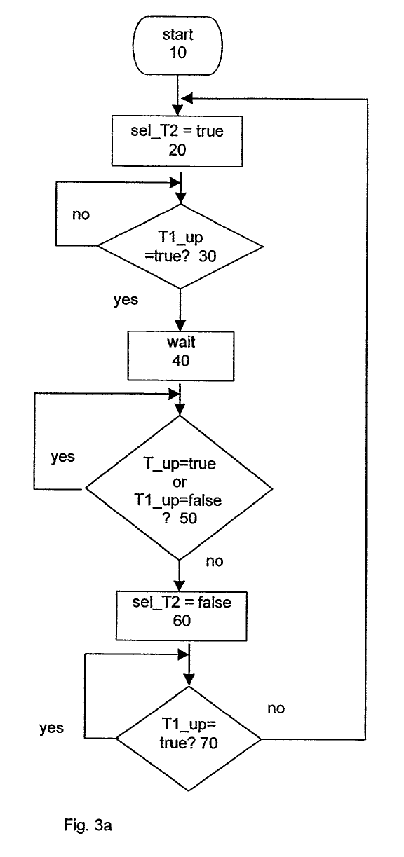

In FIG. 3, a first embodiment of an end station, ESD, according to the invention has been shown.

The end station ESD according to the invention comprises a data terminal equipment, DTE, first and second transceivers, T1 and T2, a media selector, MS, a first interface, IF1, and a second interface, IF2.

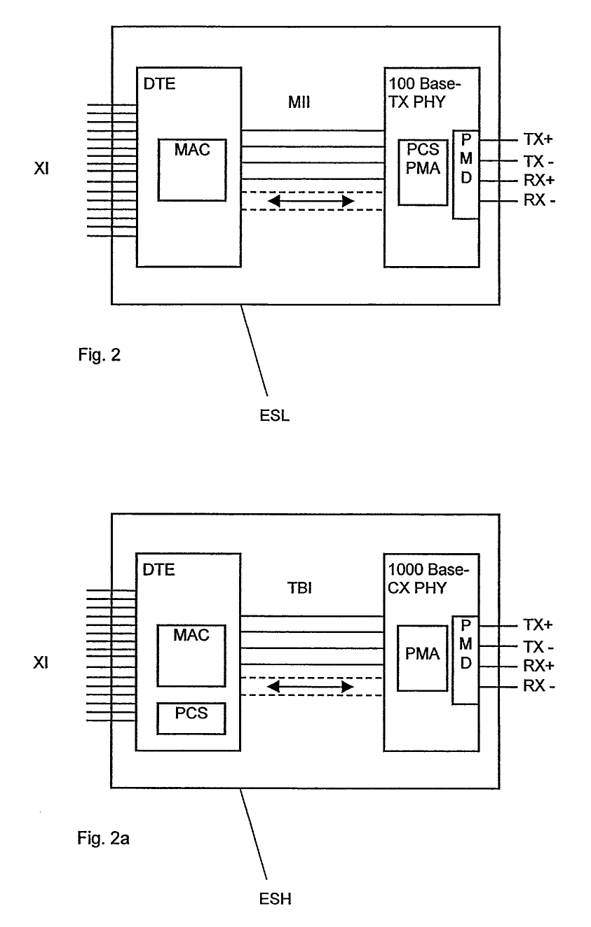

The MAC functionality of the data terminal equipment, DTE, is similar to the prior art device shown in FIG. 2, except that it is able to selectively communicate over either of the two transceivers, that is, sending and receiving information over one of the first and second interfaces, IF1 and IF2, in response to a selection signal, sel_T2.

In this embodiment, the first interface, IF1, is constituted by a MII interface while the second interface, IF2, is constituted by a TBI interface.

The data terminal equipment, DTE, is provided with a physical coding sub-layer device, PCS, for communicating over the second interface, IF2. The DTE provides a signal, T_up, indicative of whether communication to another end station over the currently selected interface, IF1 or IF2, is possible.

The first interface, MII, is connected to a first transceiver, T1, here a conventional 100 Base-TX physical transceiver operating at a first speed, and the second interface, TBI, is connected to a second transceiver, T2, here a conventional 1000 Base-CX physical transceiver, capable of operating at a second higher speed.

Both transceivers are coupled to various leads in a Cat-5, 4 pair cable, such that each transceiver occupies four leads in the cable.

The first transceiver issues a signal, T1_up, which is indicative of whether communication via the medium to an opposing end station over the first transceiver is possible. This signal is provided by many conventional transceivers.

The end station, ESD, furthermore comprises a media selector, MS, which receives the first and second signals indicative of whether communication can be performed over the first and/or second transceivers respectively, and outputs the third signal indicating which transceiver should be used.

The media selector, MS, continuously carries out a routine, whereby it establishes whether the transceivers are in an operational state, that is, whether signals can be sent over the respective transceivers to an opposing end station at the other end of the medium.

In FIG. 3a, such a routine has been shown. The routine starts in step 10. In step 20, the sel_T2 is set to a value true. This effects that the data terminal equipment pre-selects the second transceiver for communication. In step 30 the routine remains until T1_up is true. In step 40, the routine waits for a period, for example 1s. Subsequently, the routine remains in step 50 as long as either T_up is true or T1_up is false. In step 60 sel_T2 is set false and the data terminal equipment selects the first interface to communicate over. The routine waits until T1_up has turned false in step 70 and returns to step 20 in any of these cases.

Hence, if the second transceiver T2 is in an operational state, the data terminal equipment uses the second transceiver for communication. If only the first transceiver is operational, the data terminal equipment, DTE, selects the first transceiver. If none of the transceivers is available, the data terminal equipment, DTE, checks on a regular basis whether communication can be accomplished over the respective first and seconds interfaces.

The media access control unit, MAC, functions largely in the same manner as a conventional media access control unit. For instance, speed and duplex settings are adjusted to the best common setting or speed depending on the particular partner end station connected at the other end of the media and in accordance with known auto negotiation procedures.

In this manner, a dual speed Ethernet end station has been accomplished.

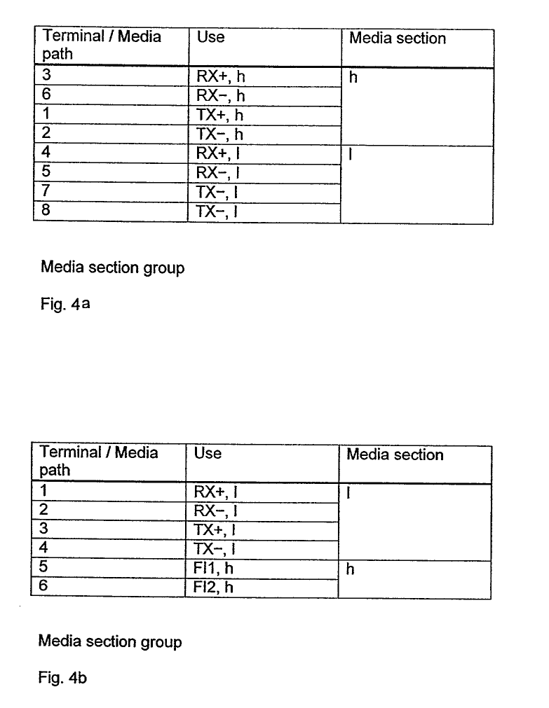

In FIG. 4, a first exemplary coupling scheme for the physical interface of the end station according to the invention shown in FIG. 3 has been shown. In this embodiment the coupling comprises a standard Cat 5, 4 pairs twisted wire connected in both ends with a terminal point such as a connector jack, having a number of terminal identification points or pins. According to the exemplary coupling scheme in FIG. 4, it is seen that in such an exemplary connector, a section of pins 1-4 denotes the transmit and receive lines of the second transceiver. Section of pins 5-8 denotes the transmit and receive lines of the first transceiver. In the following, these group of lines will be referred to shortly as I, for the first speed, and h, for the second higher speed. It should be noted that the particular arrangement of pins and lines is optional, but that one standard is preferable. In the following, the complete pair of sections h and I shown in table 4 shall be referred to as a media section group MSG. The infrastructure comprises a set of connectors such that a connection of an end station, ES, to an infrastructure is made on all media paths of at least one media section group, MSG, of the infrastructure, IFR.

It shall now be explained how the above exemplary embodiment of the invention is intended to be used.

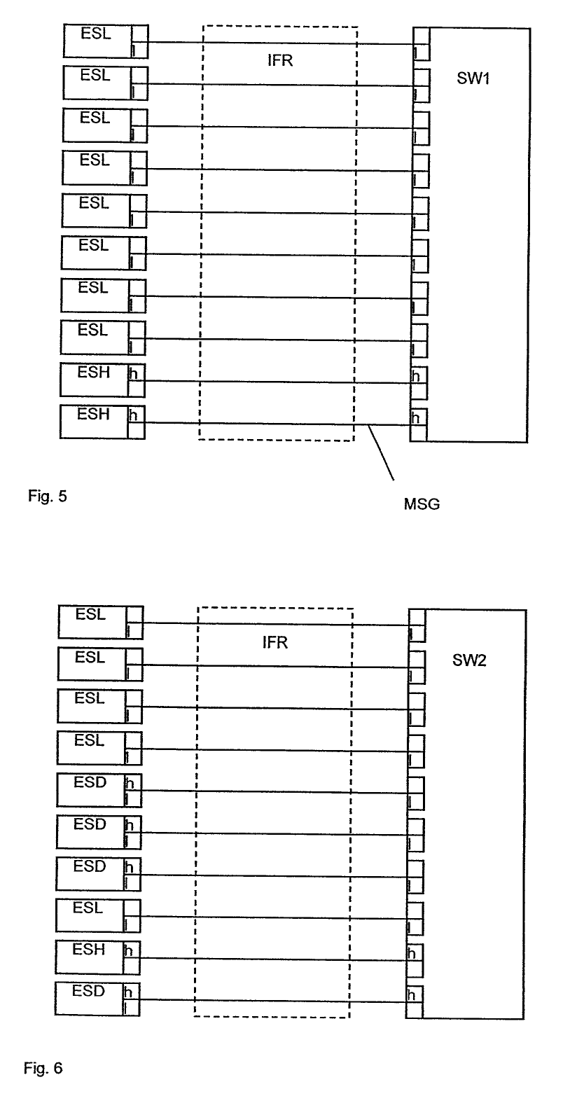

FIGS. 5-8 shows a number of modified conventional end stations, ESL and ESH, referring respectively to end stations capable of running at a first speed and second higher speed, an infrastructure according to the invention, IFR, and a modified conventional switch SW1.

The infrastructure may refer to a set of cables. In case the end stations and the switch are housed close to one another, for instance in a common rack, the infrastructure advantageously consists of a magazine providing for connections between the above elements. In this example, the infrastructure IFR, comprises a plurality of media section groups, MSG, and each media section group, MSG, comprises a pair of media sections, MSN hand MSN I, which then again comprises, in this example, four media paths, MP, each. The media paths (MP) have terminal points in both ends, for connection end station transceivers or switch ports.

The infra structure IFR is arranged in such a manner that both media sections MSN, h, I of a media section group MSG are occupied when an end station is coupled to the respective media section group MSG of the fixed infra structure IFR, and that one media section MSN, I is reserved for transceivers operating at a first speed or first ports I, while the other media section MSN, h is reserved for transceivers operating at a second speed or second ports h.

The end stations, ESL and ESH, may be of a type shown in figure FIG. 2, and be equipped with a 100 Base-TX physical transceiver or a 1000 Base-CX physical transceiver, respectively. These transceivers are equipped with a physical interface complying with the FIG. 4 coupling scheme.

It should be understood that the term first speed, I, would correspond to 100 BPS connection, as provided by the 100 Base-TX transceiver, and that the second elevated speed, h, would correspond to 1000 Mbps, as provided by the 1000 Base-CX transceiver.

The switch, SW, is modified such that its physical connectors are complying with the coupling scheme according to FIG. 4. As appears from FIG. 5, switch SW1 has 8 first speed ports and 2 second high-speed ports.

In FIG. 6, four end stations according to the invention are replacing the end stations shown in FIG. 5. Three end stations, ESD, according to the invention are replacing the end stations designated ESL and one end station, ESD, is replacing the end station ES. All the end stations, ESD, will automatically select working at their appropriate first speed, I, matching the respective ports of the switch.

No changes to the other elements of the arrangement shown in FIG. 5 are necessary for performing the replacement, providing for quick and easily performed change.

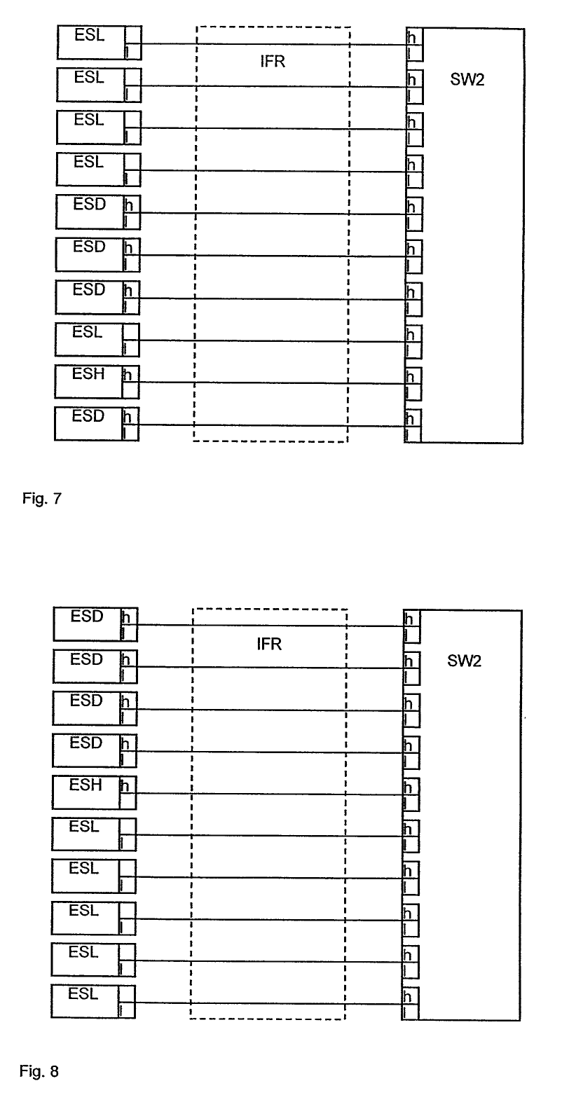

In FIG. 7, the switch, SW1, is replaced with another more capable switch SW2, having at least 10 second high speed ports, and 10 first speed ports, I, or higher. These ports are arranged according to the coupling diagram according to FIG. 4.

It is seen that the replacement of the switch SW1 with the switch SW2 can be performed easily, without any changes being necessary for the end stations or the fixed infrastructure, FI. All the end stations according to the invention now automatically select their highest speed.

Should it for some reason be decided to exchange some of the end stations with one another, i.e. re-arranging them at different ports, this can easily be accomplished, again without affecting the infrastructure, the switch or the remaining end stations.

Hence, a very flexible system has been accomplished, providing for a quick, uncomplicated and fast update to new elements or rearrangement of elements.

Advantageously, the end stations according to the invention may form part of a system comprising several microprocessor systems each being coupled to an Ethernet segment by means of the end station according to FIG. 3 and a switching hub.

According to this embodiment, each microprocessor system and end station is mounted on a circuit board and all the circuit boards are mounted in a rack together with the switching hub. The low power consumption of the end stations according to the invention enables a very compact configuration of the overall system.

### ALTERNATIVE EMBODIMENTS OF THE END STATIONS ACCORDING TO THE INVENTION

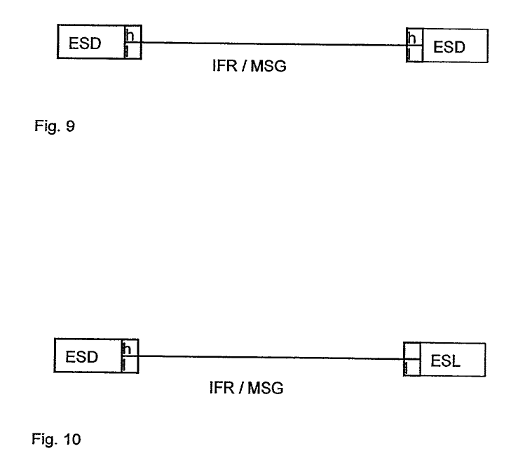

In FIG. 9, another possible use has been shown, whereby two end stations according to the invention have been coupled by a second infrastructure according to the invention utilising the coupling scheme according to FIG. 4. In this embodiment, the end stations will of course communicate over the first speed transceivers.

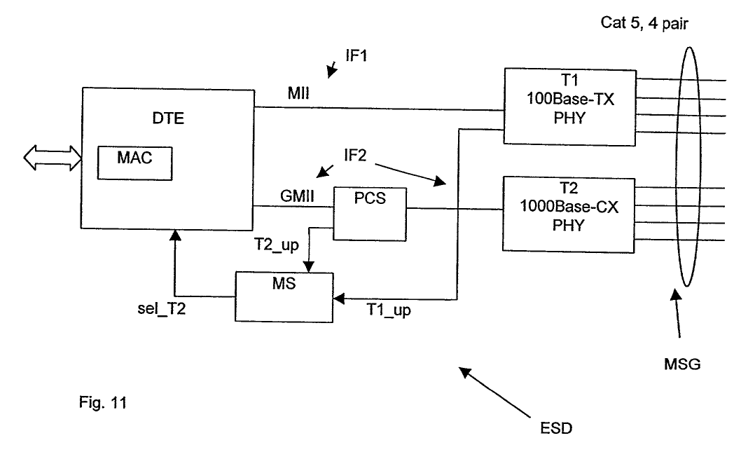

In FIG. 10, another possible use has been shown, whereby an end station according to the invention has been coupled to a conventional end station only having a first speed transceiver over the same second fixed interface shown in FIG. 9. In this instance, the end stations will of course communicate by means of the first transceivers, because no second speed transceiver is provided in the conventional end station.

An alternative embodiment of the end station according to the invention has been shown in FIG. 11.

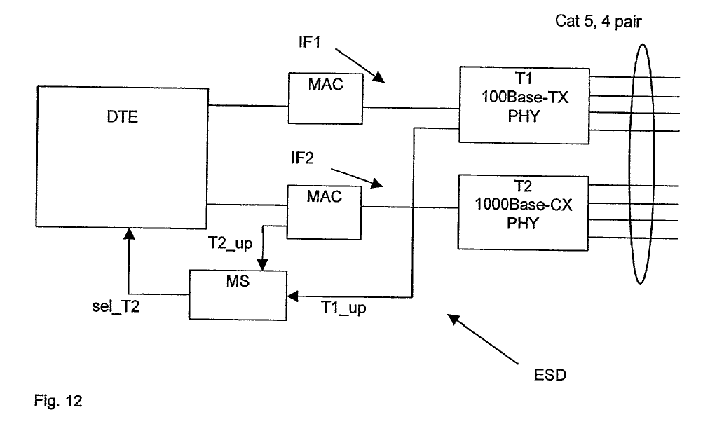

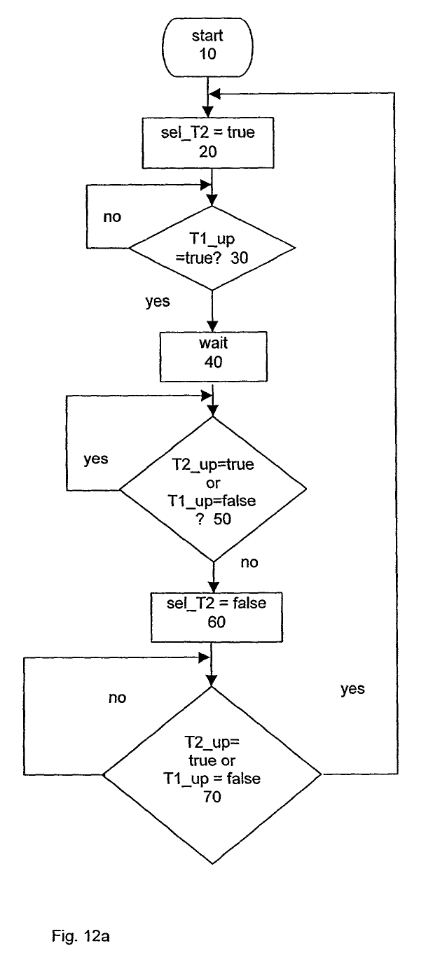

According to this embodiment, the end station is equipped with a GMII interface instead of the TBI interface in the FIG. 3 embodiment and a PCS sub-layer device is coupled in between the GMII interface of the Data Terminal Equipment and the 1000 Base-CX transceiver. However, the functionality of the device corresponds to the FIG. 12a diagram.

In FIG. 12, another alternative embodiment of an end station according to the invention has been shown. This embodiment comprises two conventional Ethernet controllers, which transfers data to “upper layer” software in the data terminal equipment. The upper layer selects which of the data streams relating to the first or the second respective transceivers should be used.

In FIG. 12a, the functionality of the above end stations in FIG. 11 and 12 has been illustrated. The routine starts in step 10. In step 20, the sel_T2 is set to a value true. This effects that the data terminal equipment pre-selects the second transceiver for communication. In step 30, the routine remains until T1_up is true. In step 40, the routine waits for a while, for instance 1 sec. In state 50, the routine remains as long as T2_up is true or T1_up is false. In step 60 sel_T2 is set false and the data terminal equipment selects the first interface to communicate over. In step 70, the routine waits until T2_up has turned true or T1_up has turned false and returns to step 20 in any of these cases.

Hence, if the second transceiver T2 is in an operational state, the data terminal equipment uses the second transceiver for communication. If only the first transceiver is operational, the data terminal equipment, DTE, selects the first transceiver. If none of the transceivers is available, the data terminal equipment, DTE, checks on a regular basis whether communication can be accomplished over the respective first and seconds interfaces.

It should be understood that many different possibilities exist for choosing first and second transceivers and the corresponding medium. For instance, copper transceivers could be combined with fibre based transceivers, or two types of fibre based transceivers could also be used, for example 1000 Base-SX and 1000 Base-LX.

In FIG. 4b, a second embodiment of a coupling scheme has been shown based on fibre and copper. According to this example, four leads provides the wire connection, while a first fibre media path, FI1, and a second fibre media path, FI2, provides connection to a fibre based transceiver (not shown).

### FURTHER EMBODIMENTS OF THE INVENTION

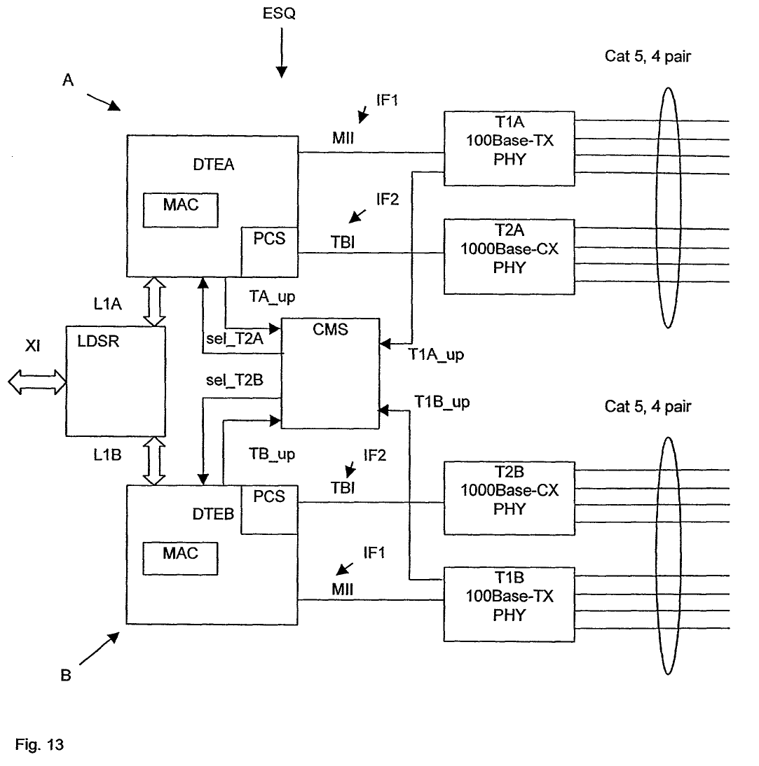

In FIG. 13, a redundant dual speed end station, ESQ, according to the invention for communicating over two redundant communication paths or LAN's has been shown.

The redundant dual speed end station, ESQ, comprises a loadsharing unit LDSR for selectively communicating over either of the two LAN's according to a loadsharing routine residing in the unit. The loadsharing mechanism is illustrated having an external Ethernet interface XI adapted to be coupled to for instance a personal computer and two other local interfaces, L1A and L1B, each being coupled to or integrated with the media access control, MAC, units of two separate data terminals, DTEA and DTEB.

The above data terminals, DTEA and DTEB, in turn, are each coupled to respective first transceivers T1A and T1B operating at a first speed, and respective second transceivers T2A and T2B, adapted to be operating at a second elevated speed. The transceivers are coupled over respective first and second interfaces in the same manner as explained in the foregoing. The transceivers again are coupled to two respective cables, here two Cat 5, 4 pair cables in the same manner as explained in the foregoing, each cable pertaining to the two separate LAN's.

The data terminals share a common media selector CMS, which receive the same signals as above, but in this case from end stations pertaining to two separate LAN's.

According to a preferred embodiment, the loadsharing unit comprises a load sharing routine, which functions in the following way: When sending a frame, the loadsharing unit selects the data terminal equipment on which a frame can be sent first. This leads to an even distribution of loads on the LAN's if we assume that both are equally busy. It one LAN is busier than the other, the loadsharing unit selects the least busy LAN.

It should be noted that the loadsharing unit could be an integrated part of the both MAC units associated with the first and second data terminal equipment, respectively.

According to another preferred embodiment of the load sharing routine, certain broadcast messages are sent on both paths A and B and it is monitored whether the messages are received at particular destinations within a certain time window from one another. If this is the case, both paths are utilised. If this is not the case, the path associated with the message falling outside the time window is deemed deficient. The deficient and/or the successive connection path for a given end station is denoted in a table in the loadsharing mechanism, and it is avoided for a predetermined time to send messages over the deficient path to the end station in question. The procedure is carried out again after a while such as to reflect the current situation with a reasonable degree of precision. This procedure both secures that frames are sent to destinations, which work and which are comparatively free from traffic.

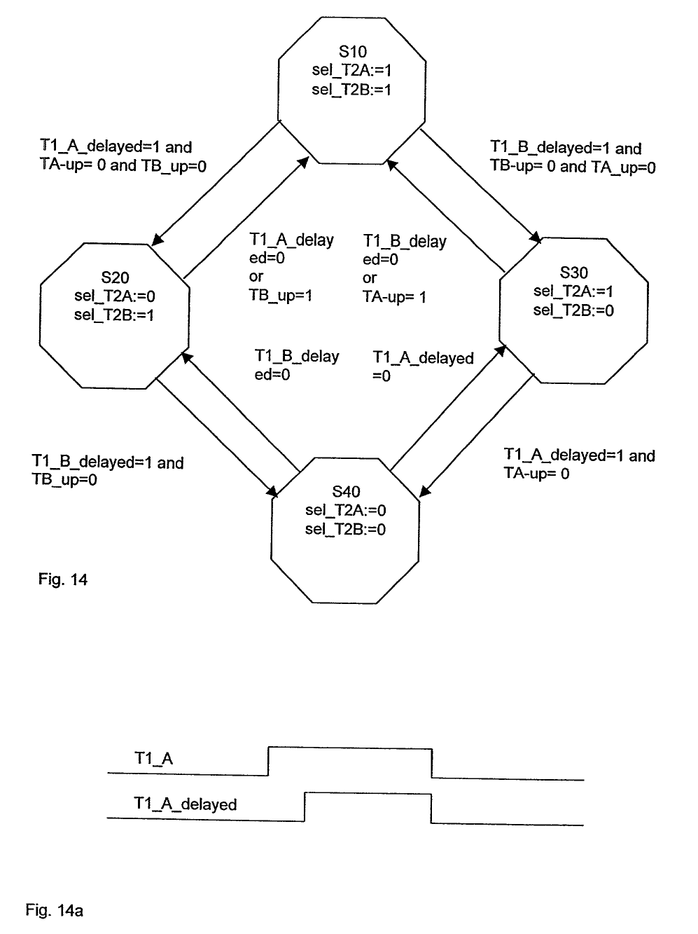

The common media selector, CMS, operates in a manner, which shall now be explained with reference to the state diagram indicated in FIG. 14 and 14a.

In FIG. 14a, two delayed signals T1A_delayed and T1B_delayed, which are derived from T1A_up and T1B_up, have been shown. When T1A_up (T1B_up) goes active (1), the T1A_delayed (T1B_delayed) does not go active (1) until a certain period. (<1s). However, as soon as T1A_up (T1B_up) goes inactive, T1A_delayed (T1B_delayed) goes inactive.

In FIG. 14, a state diagram of a preferred routine residing in the common media selector CMS have been shown, comprising four states S10, S20, S30 and S40. The state diaigram starts in state 10, where both high-speed media are selected (1, 1).

If the T1A transceiver is capable of transmitting (indicated by T1A_delayed=1) and neither T2A or T2B is capable of transmitting (indicated by TA_up and TB_up is not active;=0), state 20 is entered, in which the lower speed T1A transceiver is selected. The high-speed T2B transceiver is still selected, but is not capable of transmitting.

From state 20, the machine can either go to state 10 if the high-speed transceiver T2B is beginning to function (indicated by TB_up=1) or the low-speed transceiver T1A is unconnected. It is also possible to go to state 40, if T1B_delayed is active while T2B is still not functioning.

If the T1B transceiver is capable of transmitting (indicated by T1B_delayed =1) and neither T2A or T2B is capable of transmitting (indicated by TA_up and TB_up is not active;=0), the state machine moves to state 30, where the lower speed T1B transceiver is selected. The high-speed T2A transceiver is still selected, but is not capable of transmitting.

From state 30, the machine can either go to state 10 if the high-speed transceiver T2A is beginning to function (indicated by TA_up=1) or the low-speed transceiver T1B is unconnected. It is also possible to go to state 40, if T1A_delayed is active while T2A is still not functioning.

In state 40 both low-speed media have been selected. The only way to go from that state is if one of the low speed media stops functioning (indicated by T1B_delayed or T1A_delayed =0).

According to the above state diagram, it appears that if one or both of the second high-speed transceivers are found operational, the common media selector, CMS, will choose both high-speed transceivers.

When a low-speed transceiver is chosen, it can be established whether the high-speed transceiver is operational by turning off the low-speed transceiver and selecting the high-speed transceiver. However, if both media are in the same connector or media section group, this will not be a problem, because it is impossible to upgrade an end station without disconnecting the low-speed media.

Only, in case both second high-speed transceivers are found non-operational, the common media selector CMS will choose first transceivers, T1A and T1B. This obviates that load is transmitted over a first speed transceiver, if a second transceiver offering an elevated speed is available. Consequently, the traffic is performed more efficiently.

It should be noted that, apart from sharing the load on two LAN's, the above structure also offers a measure of redundancy. If one of the LAN's is not working properly, the loadsharing unit will choose the functional one.

According to the invention, it is invisible to the upper MAC layers through which actual transceiver T1A, T2A, T1B and T2B the traffic is actually floating, or put in other words the function of the loadsharing unit LDSR is independent of the function of the common media selector, CMS.

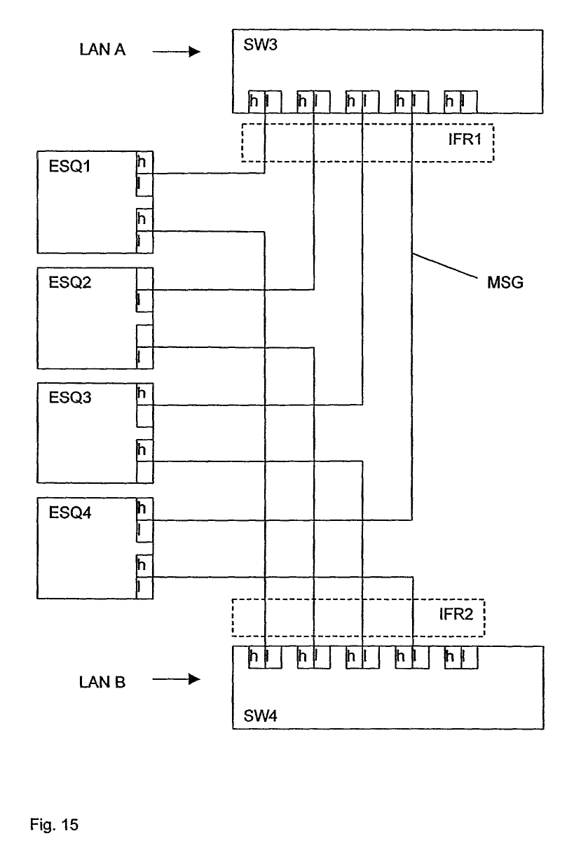

In FIG. 15, four dual speed redundant end stations ESQ1, ESQ2, ESQ3 and ESQ4 according to the invention have been coupled to two LAN's A and B through respective switches SW3 and SW4, by way of example. As appears from the figure, the various end stations have different speed capabilities in line with the foregoing examples. For instance, the end station ESQ2 only has first speed ports, while ESQ1 are fully equipped with two low speed ports and two high speed ports.

The coupling to the various switches is accomplished through the infrastructure according to the invention, IFR1 and IFR2, which allows for a very easy, uncomplicated and secure way of connecting the devices and later provides for carrying out up-dates in the system.

### REFERENCE SIGNS

local area network LAN

Ethernet system ETHS

media access control MAC

attachment unit interface AUI

media independent interface MII

gigabit media independent interface GMII

ten bit interface TBI

physical coding sub-layer PCs

physical medium attachment PMA

physical medium dependent PMD

first fibre media path FI1

second fibre media path FI2

end station ES

first speed end station ESL

second speed end station ESH

dual speed end station ESD

data terminal equipment DTE

transceiver TR

first speed transceiver TRL

second speed transceiver TRH

media selector MS

common media selector CMS

first interface IF1

second interface IF2

first switch SW1

second switch SW2

infrastructure IFR, IFR1, IFR2

media section MSN

media path MP

media section group MSG

terminal point TP

first speed port I

second speed port h

external Ethernet interface XI

first local interface L1A

second local interface L1B

redundant dual speed end station ESQ

load sharing unit LDSR

first local area network LAN A

second local area network LAN B

1. An Ethernet system comprising,
an Ethernet switch (SW), having a number of first ports (I), being adapted to communicate at a first speed and a number of second ports (h) being adapted to operate at a second higher speed, the switching device defining a number of Ethernet segments over each respective port, each port being adapted to route incoming messages according to their destination addresses, while storing the departure addresses in a routing table, the switching device comprising a memory buffer for momentarily storing messages being communicated over the ports,
a plurality of end stations (ES), each end station having at least one Ethernet transceiver (T1; T2) and being adapted to be coupled to one of either said first and second ports (I, h), respectively over media paths (MP)
characterised in that
the system comprises an infrastructure (IFR, IFR1, IFR2), comprising at least one media section group (MSG), the at least one media section group (MSG) comprising a first media section (MSN, I) and a second media section (MSN, h), the first and the second media section, comprising a number of media paths (MP) having terminal points in both ends,
the infra structure (IFR, IFR1, IFR2) being arranged in such a manner that all media sections (MSN, h, I) of a media section group (MSG) are occupied when an end station is coupled to the respective media section group (MSG) of the fixed infra structure (IFR), and that one media section (MSN, I) is reserved for transceivers operating at a first speed or first ports (I) while the other media section (MSN, h) is reserved for transceivers operating at a second speed or second ports (h).

2. Ethernet system according to claim 1, comprising
an end station (ESD; ESH; ESL) having a first speed transceiver (T1) and/or a second higher speed transceiver (T2), whereby when the end station is coupled over the respective first and second media sections (MSN, h, I) of an arbitrary media section group (MSG) of the infrastructure (IFR) to a switch (SW) for instance, the first speed transceiver (T1) is connected with a first speed port (I) of the switch, if existing, and the second speed transceiver (T2) is connected with a second speed port (h), if existing.

3. Ethernet system according to claim 2, whereby the first transceiver is a 100 Base-TX transceiver and the second transceiver is a 1000 Base-CX transceiver and wherein the media section group consists of a Cat 5, 4 pair twisted cable.

4. Ethernet system according to claim 2 or 3, whereby the infrastructure (IFR) consists of a magazine of Cat 5, 4 pair cables.

5. Ethernet system according to claim 2, wherein the first media section (MSN, h) of a media section group (MSG) consists of media being different from the media of the second media section (MSN, I) in the same media section group (MSG).

6. End station (ESD) comprising
a data terminal equipment (DTE) comprising at least one media access control unit for media access control (MAC) and signal conversion between high level protocol signals to reconciliation signals,
a first transceiver (T1; T2) being coupled to the data terminal equipment (DTE) over a first interface (MII), the first transceiver being adapted to be coupled to media paths (MP), the first transceiver (T1) being capable of operating at a first speed,
characterised in that
the end station (ESD) furthermore comprising
a second transceiver (T1; T2) being coupled to the data terminal equipment (DTE) and being adapted to be coupled to a second media section (MSN), offering media paths (MP) distinct from a first media section, the second transceiver (T1; T2) being capable of operating at a second speed,
the first and the second transceiver (T1, T2) being adapted to convert signals from connector signals to physical media signalling on the respective media paths (MP),
a media selector (MS) for monitoring whether signals can be transmitted over the first transceiver (T1) or over the second transceiver (T2), respectively, to opposing switch ports or transceivers and if signals can be transmitted over the second transceiver (T2) controlling the end station (ESD) to communicate over the second transceiver (T2), and otherwise controlling the data terminal equipment (DTE) to communicate over the first transceiver (T1).

7. End station according to claim 6, whereby the media selector (MS) derives a signal from the first transceiver and the second transceiver (T1_up; T2_up), respectively being indicative of whether communication can be performed over the respective transceiver (T1, T2).

8. End station according to claim 6, whereby the media selector (MS) derives a signal (T1_up) from the first transceiver (T1) being indicative of whether communication can be performed over the first transceiver (T1), and whereby the media selector derives a signal (T_up) from the data terminal equipment (DTE) being indicative of whether communication can be performed over either the first or the second transceiver (T1, T2).

9. End station according to claim 6, 7 or 8 whereby the first transceiver is a 100 Base TX transceiver and the first interface is a MII interface, and wherein the second transceiver is a 1000 Base CX transceiver and the second interface is a TBI or a GMII interface.

10. End station according to claim 7, comprising a PCS sub-layer being interposed in the signal path between the second transceiver and the data terminal equipment (DTE), whereby the PCS sub-layer provides a signal (T2-up) being indicative of whether the second transceiver is communicating.

11. End station according to claim 6, whereby the data terminal equipment (DTE) comprises two separate media access controllers (MAC) and an upper layer Ethernet control.

12. End station (ESQ) comprising
at least two data terminal equipments (DTEA; DTEB) each comprising at least one media access control unit for media access control (MAC) and signal conversion between high level protocol signals to reconciliation signals, such as MII signalling,
the data terminal equipments being adapted for to be coupled redundant LAN's (LAN A, LAN B), whereby the respective data terminal equipments comprises a loadsharing mechanism (LDSR),
each respective data terminal equipment being coupled to
a first transceiver (T1) being coupled to the data terminal equipment (DTE) over a first interface (IF1), the first transceiver (T1) being capable of operating at a first speed, and being coupled to a first media section (MSN, I),
a second transceiver (T2) capable of operating at a second speed and being coupled to the data terminal equipment (DTE) over a second interface (IF2) and being adapted to be coupled to a second media section (MSN, h), distinct from the first media section, the second transceiver (T1; T2) being capable of operating at a second speed, whereby the first and the second transceiver (T1, T2) is adapted to convert signals from connector signals to physical media signalling on the respective media paths (MP), the end station moreover comprising
a common media selector (MS) for monitoring whether signals can be transmitted over the respective first transceivers (T1) or over the second transceivers (T2), respectively, to opposing switch ports or transceivers and if signals can be transmitted over at least one second transceiver (T2), the common media sector (CMS) controlling at least one of the data terminal equipments (DTEA, DTEB) to communicate over the second transceiver (T2A, T2B).

13. End station according to claim 12, whereby if the signals can be transmitted over at least one second transceiver (T2A, T2B), the common media selector (CMS) controls both data terminal equipments (DTEA, DTEB) to communicate over both second transceivers (T2A, T2B), despite one of the second transceivers being non-operational and if none of the second transceivers are operational controlling the data terminal equipments (DTEA, DTEB) to communicate over the first transceivers.

14. End station according to claim 13, moreover comprising a loadsharing unit (LDSR), which distributes the load on the two redundant LAN's (LAN A, LAN B) and which monitors whether a LAN is considered deficient, and in case a particular LAN is considered deficient using the other LAN.

15. End station according to any preceding claim, wherein the selection of the first or second transceiver is invisible to the MAC layer in the data terminal equipment (DTE).
